(19) United States
(12) Patent Application Publication
(10) Pub. No.: US 2009/0100308 A1
(43) Pub. Date: Apr. 16, 2009

(54) DIGITAL VOICE COMMUNICATION METHOD AND DIGITAL VOICE COMMUNICATION APPARTUS

(75) Inventor: Akinori HIROSE, Tokyo (JP)

Correspondence Address: Studebaker & Brackett PC, 1890 Preston White Drive, Suite 105, Reston, VA, 20191, US

(73) Assignee: Oki Electric Industry Co., Ltd., Tokyo (JP)

(21) Appl. No.: 12/207,525

(22) Filed: Sep. 10, 2008

(30) Foreign Application Priority Data
Oct. 11, 2007 (JP) 2007265413

(51) Int. Cl. H04L 1/00; G06F 11/07

(52) U.S. Cl. 714/747; 714/E11.023

(57) ABSTRACT

The present invention provides a digital voice communication apparatus and method capable of suppressing noise even when error data has occurred in digital voice communications. A data receiving unit divides received data into ADPCM frame data and outputs the same together with frame error information about an error of each ADPCM frame data. A G. 726 decoder performs decoding defined in G. 726 of the ITU-T recommendation to convert the ADPCM frame data to PCM system-based data and outputs the same data to a Claw error correction processing unit. When no error is contained in the frame data, the μ-law error correction processing unit outputs the inputted frame data to a G. 711 decoder as it is. When the error is contained in the frame data, the μ-law error correction processing unit sets a substitution range, based on maximum and minimum values of normal frame data located immediately before the frame data and substitutes the error-contained frame data with data lying within the substitution range.

### BACKGROUND OF THE INVENTION

The present invention relates to a digital voice communication method and a digital voice communication apparatus, and particularly to a digital voice communication method and a digital voice communication apparatus each suitable for use in where error detection and an error correcting process are performed on received data to decode the same.

In general, in digital voice communications, a sampled audio or voice signal is compressed in accordance with a system such as ADPCM (Adaptive Differential Pulse Code Modulation) or the like and data-transferred in frame units. This voice-compressed frame data is generally added with an error correction code. When data is garbled under the influence of noise or the like during communication, an error in data can be detected using this error correction code. When the error in data is detected, an error correction is conducted if it is within an allowable range for the error correction. If it falls outside the allowable range, then the output of an error detection signal as false or error data, and the like are conducted.

There is a case in which when such voice-compressed frame data recognized as the error is expanded and reproduced as it is, the volume changes abruptly, and needless frequency components are generated and heard as noise.

As measures against the above, there have been proposed, for example, approaches to reducing audibility noise by reproducing frame data prior to damaged voice-compressed frame data in place of the damaged voice-compressed frame data in digital voice communications using an ADPCM system (refer to a patent document 1 (Japanese Unexamined Patent Publication No. 2007-6359)), and replacing data in accordance with the specific rules (refer to a patent document 2 (Japanese Unexamined Patent Publication No. 2006-50476)).

Here, a schematic block diagram of a decoder provided in a receiver used in conventional digital voice communications is shown in FIG. 6.

As shown in FIG. 6, the decoder 100 includes a data receiver or receiving unit 102, an ADPCM error correction processor or processing unit 104, a G. 726 decoder 106 and a G. 711 decoder 108.

The data receiving unit 102 performs, every frame, error detection and an error correcting process on received data 110 obtained by adding an error correction code to ADPCM data in which a voice or audio signal has been compression-encoded by ADPCM, for example, divides the ADPCM data into individual ADPCM frame data, and outputs the ADPCM frame data 112 and frame error information 114 about an error in the ADPCM frame data in sync with a sync signal 116. Incidentally, the frame error information 114 changes according to the circumstances of errors of the respective frames.

When the frame error information 114 outputted from the data receiving unit 102 is true (false), the ADPCM error correction processing unit 104 performs such correction processing as described in, for example, the patent documents 1 and 2 on the corresponding ADPCM frame data 112. On the other hand, the frame data in a period during which the frame error information 114 is false (normal) is outputted as it is without its correction.

The G. 726 decoder 106 performs decoding defined in G. 726 of the ITU-T (International Telecommunication Union Telecommunication Standardization Sector) recommendation on the corrected ADPCM frame data 118 processed by the ADPCM error correction processing unit 104 and outputs the same to the G. 711 decoder 108 as corrected μ-law data 120. Incidentally, ADPCM coding or the like is defined in G. 726 of the ITU-T recommendation.

The G. 711 decoder 108 performs decoding defined in G. 711 of the ITU-T recommendation on the corrected μ-law data 120 outputted from the G. 726 decoder 106 and outputs the same to an unillustrated subsequent-stage audio or voice output circuit as corrected PCM data 122. Thus, voice or audio reproduction is performed. PCM coding or the like is defined in G. 711 of the ITU-T recommendation.

Decoding the received data in this way enables concealing of error or false data in terms of audibility.

Recently, in order to enlarge or extend a digital voice communication range, communications is in the process of being conducted at low bit rates by high-compressing transmitted digital audio or voice data. In the current Japanese PHS services, for example, digital voice and data communications at low bit rates using a 16-kbps ADPCM system have been conducted in an area weak in radio field intensity. There is however a case where since the digital voice data high-compressed in this way is reduced in the amount of information, noise or the like in the digital voice data cannot be suppressed sufficiently even though such an ADPCM error correcting process as described in the above related art is done.

When, for example, the false or error data is replaced and expanded/reproduced as in the related art, the number of substitution candidate patterns at 16-kbps ADPCM, including only an amount of information corresponding to 2 bits is merely ¼ of 32-kbps ADPCM with respect to the number of substitution candidate patterns at 32-kbps ADPCM, including an amount of information corresponding to 4 bits. Therefore, a problem arises in that there is a case in which the predicted conversion accuracy of ADPCM is rough and the voice data expanded by substitution is also heard like noise.

### SUMMARY OF THE INVENTION

The present invention has been proposed to solve the above problems. It is an object of the present invention to provide a digital voice communication method and a digital voice communication apparatus each capable of suppressing noise even when false or error data occurs in digital voice communications.

According to a first aspect of the present invention, for attaining the above object, there is provided a digital voice communication method comprising the steps of detecting whether an error exists every frame data obtained by dividing received data; when the error exists in each frame data, setting a substitution range, based on normal frame data located immediately before the corresponding error-present frame data; and substituting data lying outside the substitution range, of the error-present frame data with data lying within the substitution range.

According to the present invention, when an error exists in each frame data, a substitution range is set based on normal frame data placed immediately before the corresponding error-present frame data. Data lying outside the substitution range, of the error-present frame data is substituted with data lying within the substitution range. Thus, since the error-present frame data can be substituted with data that is not much different from the normal frame data lying immediately before it, noise can be suppressed.

As described in a second aspect of the present invention, the setting step can set a maximum value of data contained in the normal frame data as an upper limit of the substitution range and set a minimum value of data contained in the normal frame data as a lower limit of the substitution range.

As described in a third aspect of the present invention, the setting step can set a first substitution range for replacing positive data and a second substitution range for replacing negative data, based on an absolute value of the maximum value of the data contained in the normal frame data and an absolute value of the minimum value of the data contained in the normal frame data.

As described in a fourth aspect of the present invention, the frame data can be set as data encoded by a PCM system.

According to a fifth aspect of the present invention, for attaining the above object, there is provided a digital voice communication apparatus comprising means for detecting whether an error exists every frame data obtained by dividing received data, means for, when the error exists in each frame data, setting a substitution range, based on normal frame data located immediately before the corresponding error-present frame data, and means for substituting data lying outside the substitution range, of the error-present frame data with data lying within the substitution range.

According to the present invention, when an error exists in each frame data, a substitution range is set based on normal frame data placed immediately before the corresponding error-present frame data. Data lying outside the substitution range, of the error-present frame data is substituted with data lying within the substitution range. Thus, since the error-present frame data can be substituted with data that is not much different from the normal frame data lying immediately before it, noise can be suppressed.

According to the present invention as described above, an advantageous effect is brought about in that even when false or error data occurs in digital voice communications, noise can be suppressed

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a schematic block diagram of a decoder according to a first embodiment of the present invention;

FIG. 2 is a schematic block diagram of a μ-law error correction processing unit of the decoder according to the first embodiment of the present invention;

FIG. 3 is a flowchart for describing processing executed by the μ-law error correction processing unit;

FIG. 4(A) is a diagram showing one example of error-free reproduction data containing no error, FIG. 4(B) is a diagram showing one example of error-presence reproduction data containing an error, and FIG. 4(C) is a diagram showing one example of error-corrected reproduction data obtained by correcting error-contained reproduction data;

FIG. 5 is a schematic block diagram of a decoder according to a second embodiment of the present invention; and

FIG. 6 is a schematic block diagram of a decoder according to a conventional example.

### DETAILED DESCRIPTION OF THE PREFERRED EMBODIMENTS

Preferred embodiments of the present invention will hereinafter be described in detail with reference to the accompanying drawings.

### First Preferred Embodiment

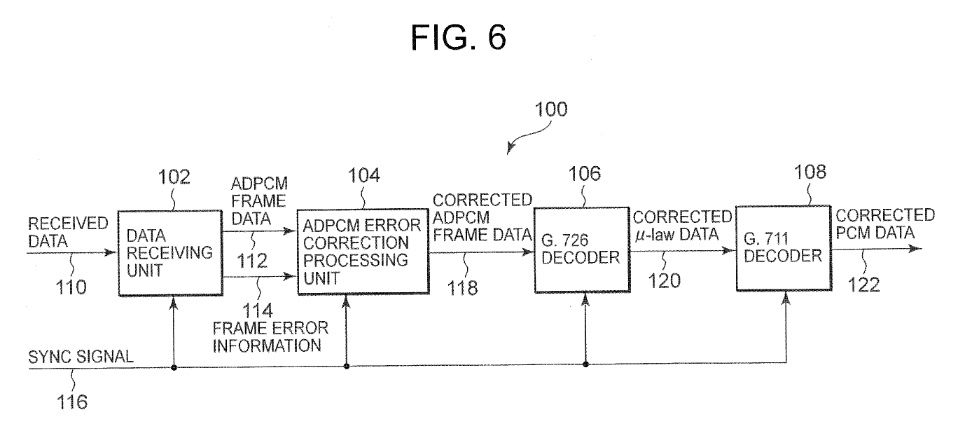

A schematic block diagram of a decoder 10 used as a digital voice communication apparatus according to the present embodiment. Incidentally, the same reference numerals are respectively attached to the same portions as those of the decoder 100 shown in FIG. 6, and their detailed explanations will be omitted.

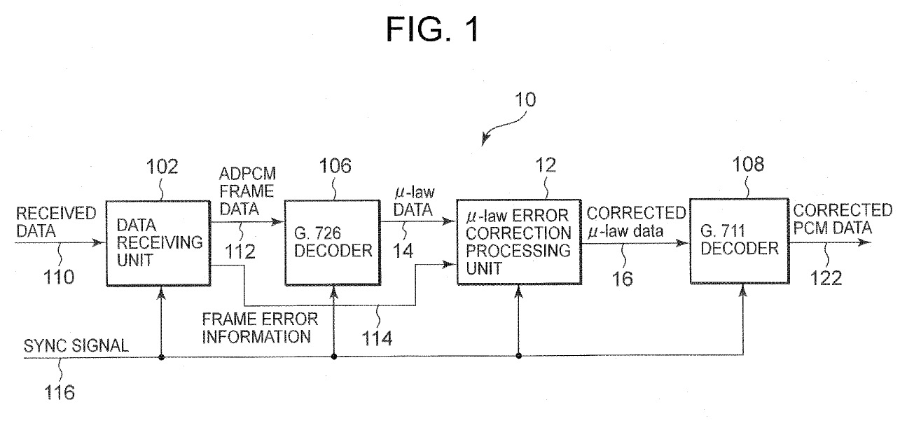

As shown in FIG. 1, the decoder 10 includes a data receiver or receiving unit 102, a G. 726 decoder 106, a μ-law error correction processor or processing unit 12 and a G. 711 decoder 108.

The data receiving unit 102 performs, every frame, error detection and an error correcting process on received data 110 obtained by adding an error correction code to ADPCM data in which a voice or audio signal has been compression-encoded by ADPCM, divides the ADPCM data into individual ADPCM frame data, and outputs the ADPCM frame data 112 and frame error information 114 about an error in the ADPCM frame data to the G. 726 decoder 106 in sync with a sync signal 116.

The G. 726 decoder 106 performs decoding defined in G. 726 of the ITU-T recommendation on the ADPCM frame data 112 outputted from the data receiving unit 102 to convert into PCM system-based data and outputs the same to the μ-law error correction processing unit 12 as μ-law data 14.

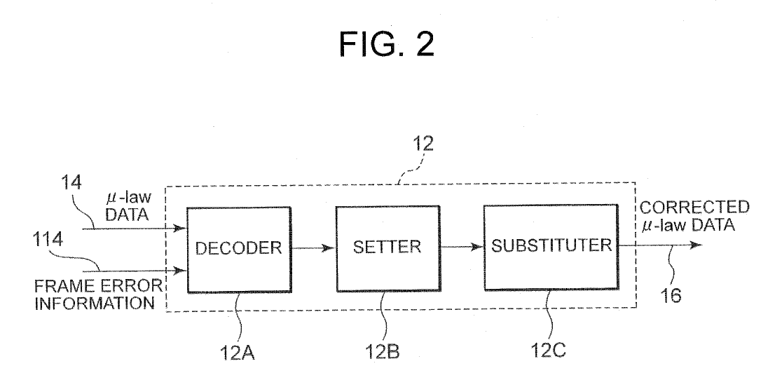

A functional block diagram of the μ-law error correction processing unit 12 is shown in FIG. 2. As shown in the same drawing, the μ-law error correction processing unit 12 includes a detector or detection unit 12A which detects, based on the frame error information 114 outputted from the data receiving unit 102 whether an error exists in the μ-law data 14 (frame data) outputted from the G. 726 decoder 106, a setter or setting unit 12B which, when the error is detected in the frame data, sets a substitution range of the error-present frame data, based on its immediately preceding normal frame data, and a substituter or substitution unit 12C which substitutes the error-present frame data into the substitution range set by the setter 12B.

That is, when no error is contained in the frame data, the μ-law error correction processing unit 12 outputs the inputted frame data to the G. 711 decoder 108 as it is. When the error is contained in the frame data, the μ-law error correction processing unit 12 replaces data lying outside the substitution range, of the frame data with data lying within the substitution range and outputs the same to the G. 711 decoder 108.

The G. 711 decoder 108 performs decoding defined in G. 711 of the ITU-T recommendation on corrected μ-law data 16 outputted from the μ-law error correction processing unit 12 and outputs the decoded data to an unillustrated subsequent-stage voice or audio output circuit as corrected PCM data 122. Thus, voice or audio reproduction is conducted.

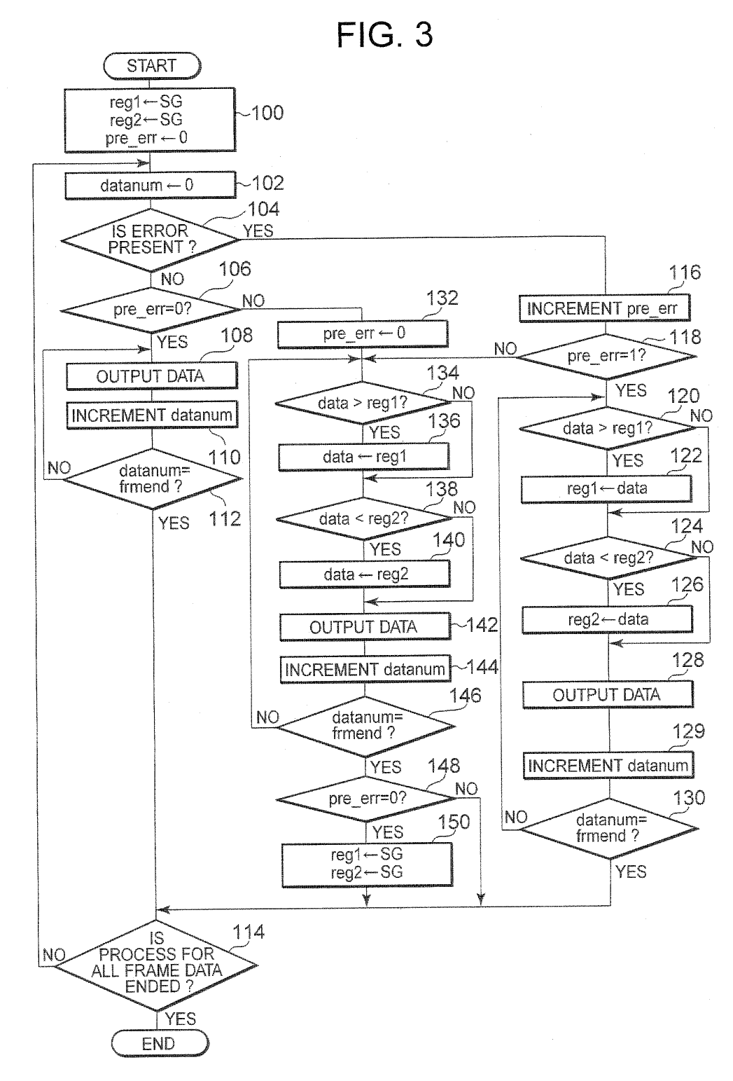

Processing executed by the μ-law error correction processing unit 12 will next be described as the operation of the present embodiment with reference to a flowchart shown in FIG. 3.

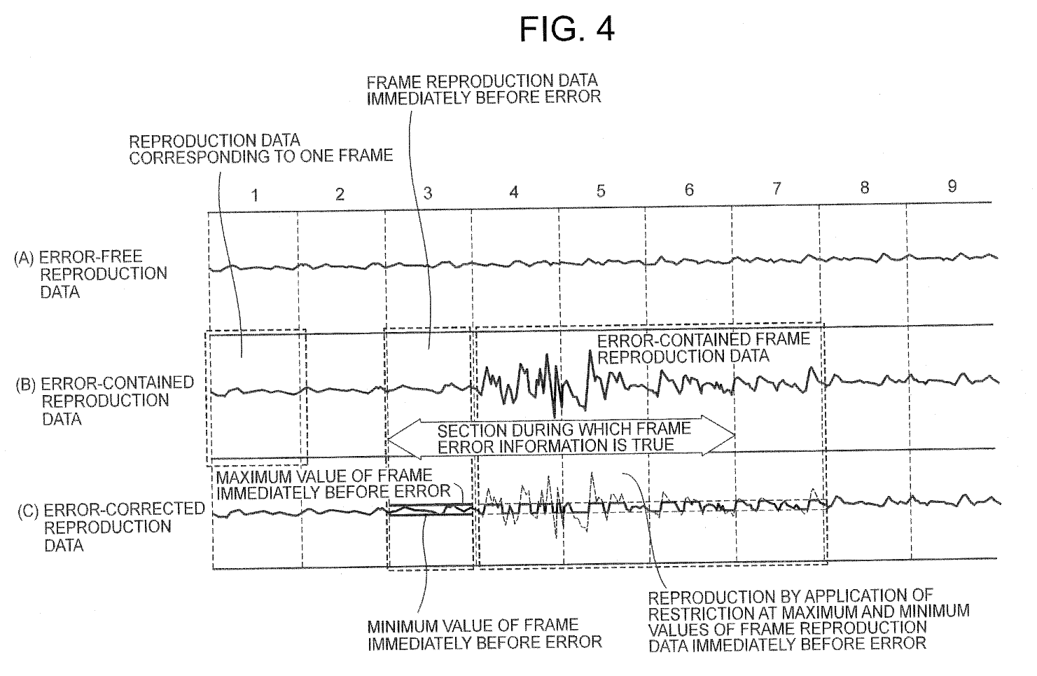

Incidentally, assume that the processing time corresponding to one frame is required to expand audio-compressed frame data in the present embodimemt. That is, frame error information 114 inputted to the μ-law error correction processing unit 12 is assumed to be frame error information about frame data lying next to frame data inputted to the μ-law error correction processing unit 12. When error are contained between fourth and seventh frames as shown in FIG. 4(B) by way of example, frame error information 114 corresponding to the next fourth frame is inputted to the μ-law error correction processing unit 12 when a third frame corresponding to normal frame data is being processed by the μ-law error correction processing unit 12.

Assume that in FIG. 3, a frame error counter indicative of the number of error-contained or present frame data is pre_err, a data counter lying within a frame is datanum, the total number of data within the frame is frmend, each data of expanded frame data is data, and two storage or memory areas provided within the μ-law error correction processing unit 12 are reg1 and reg2 respectively.

At Step 100, a predetermined signal reference value SG is stored in the storage regions reg1 and reg2. Further, ‘0’ is set to the frame error counter pre_err. The signal reference value SG is determined in advance according to the level of decoded audio or voice data. For example, ‘0’ is set as the signal reference value, but the signal reference value is not limited to or by it.

At Step 102, ‘0’ is set to the data counter datanum. At Step 104, it is determined based on frame error information 114 whether an error is contained in frame data. The frame data error information 114 is of frame error information about the next frame data as mentioned above.

When no error exists in the next frame data, the present routine proceeds to Step 106. When the error exists in the next frame data, the present routine proceeds to Step 116.

At Step 106, it is determined whether the frame error counter pre_err is ‘0’. When it is ‘0’, the present routine proceeds to Step 108. When it is not ‘0’, the present routine proceeds to Step 132.

At Step 108, data data is outputted. At Step 110, the data counter datanum is incremented.

At Step 112, it is determined whether the data counter datanum is the total number of data frmend, that is, it is determined whether all data in the frame are outputted. When all the data in the frame are outputted, the present routine proceeds to Step 114. When there is non-outputted data, the present routine proceeds to Step 108, where the present routine is repeated until all the data are outputted.

At Step 114, it is determined whether a process about all frame data has been terminated. When the process about all the data is ended, the present routine is terminated. When the non-processed frame data exists, the present routine proceeds to Step 102.

When all inputted frame data are of error-free reproduction data containing no error as shown in FIG. 4(A), for example, the processes of Steps 102 through 114 are repeated and the inputted frame data are outputted to the subsequent-stage G. 711 decoder 108 as they are without being corrected.

On the other hand, when it is determined at Step 104 that an error exists in the next frame data, the present routine proceeds to Step 116 where the error counter pre_err is incremented.

At Step 118, it is determined whether the error counter pre_err is ‘1’, that is, it is determined whether the following frame data corresponds to first frame data containing an error. When the error counter pre_err is ‘1’, the present routine proceeds to Step 120. When the error counter pre_err is not ‘1’, that is, error-present frame data is continuous, the present routine proceeds to Step 134.

At Step S120, it is determined whether data data is larger than the value of the storage region reg1. When the data data is larger than the value, the present routine proceeds to Step 122, where the value of the storage region reg1 is rewritten to its corresponding data data. On the other hand, when the data data is not larger than the value of the storage region reg1, the present routine proceeds to Step 124.

At Step 124, it is determined whether the data data is smaller than the value of the storage region reg2. When it is smaller that the value, the present routine proceeds to Step 126, where the value of the storage region reg2 is rewritten to its corresponding data data. On the other hand, when the data data is not smaller than the value of the storage region reg2, the present routine proceeds to Step 128.

At Step 128, the data data is outputted to the subsequent-stage G. 711 decoder 108. At Step 129, the data counter datanum is incremented.

At Step 130, it is determined whether the data counter datanum is the total number of data frmend, that is, it is determined whether all data in the frame are outputted. When all the data in the frame are outputted, the present routine proceeds to Step 114. When there is non-outputted data, the present routine proceeds to Step 120, where the present routine is repeated until all the data are outputted.

That is, in the processes of Steps 120 through 130, the maximum value of the present or current frame data corresponding to frame data placed immediately before the error-present frame data is stored in the storage region reg1 as the upper limit of a substitution range at the time that the value of the error-present frame data is replaced with another. The minimum value of the frame data is stored in the storage region reg2 as the lower limit of the substitution range.

In the case of the error-present reproduction data in which the error is contained in the frame data between the fourth and seventh frames of the inputted data as shown in FIG. 4(B) by way of example, the maximum value of the frame data corresponding to the third frame placed immediately before the fourth frame is stored in the storage region reg1. The minimum value of the frame data corresponding to the third frame is stored in the storage region reg2.

On the other hand, when it is determined at Step 118 that the error counter pre_err is not ‘1’, that is, when the error-present frame data is continuous, the present routine proceeds to Step 134, where it is determined whether the data data is larger than the value of the storage region reg1. When the data data is greater than the value of the storage region reg1, the present routine proceeds to Step 136. When the data data is not larger than the value of the storage region reg1, the present routine proceeds to Step 138.

At Step 136, the data data is substituted with the value of the storage region reg1.

At Step 138, it is determined whether the data data is smaller than the value of the storage region reg2. When the data data is smaller than the value of the storage region reg2, the present routine proceeds to Step 140. When the data data is not smaller than the value of the storage region reg2, the present routine proceeds to Step 142.

At Step 140, the data data is replaced with the value of the storage region reg2.

At Step 142, the data data is outputted to the G. 711 decoder 108. At Step 144, the data counter datanum is incremented.

At Step 146, it is determined whether the data counter datanum is the total number of data frmend, that is, it is determined whether all data in the frame are outputted. When all the data in the frame are outputted, the present routine proceeds to Step 148. When there is non-outputted data, the present routine proceeds to Step 134, where the present routine is repeated until all the data are outputted.

That is, in the processes of Steps 134 through 146, the data data that exceeds the upper limit of the substitution range, of the frame data is substituted with the value of the storage region reg1, corresponding to the upper limit value of the substitution range. The data data that exceeds the lower limit of the substitution range, of the frame data is substituted with the value of the storage region reg2, corresponding to the lower limit value of the substitution range.

In the case of the error-present reproduction data in which the error is contained in the frame data between the fourth and seventh frames of the inputted data as shown in FIG. 4(B) by way of example, the processes of Steps 134 through 146 are performed on the frame data between the fourth and seventh frames, whereby the frame data from the fourth to seventh frames are limited to within the substitution range as shown in FIG. 4(C).

At Step 148, it is determined whether the error counter pre_err is ‘0’. When the error counter pre_err is ‘0’, the present routine proceeds to Step 150. When the error counter pre_err is not ‘0’, the present routine proceeds to Step 114.

At Step 150, the values of the storage regions reg1 and reg2 are reset to the signal reference value SG, and the present routine proceeds to Step 114.

On the other hand, when it is determined at Step 106 that the error counter pre_err is not ‘0’, that is, when the frame data placed next to the current error-contained frame data is of error-free normal frame data, the present routine proceeds to Step 132, where the error counter pre_err is reset to ‘0’.

The error-present current frame data is substituted with the frame data lying within the substitution range by the processes of Steps 134 through 146. At Step 148, an affirmative decision is made because the error counter pre_err is reset to ‘0’ at Step 132. At Step 150, the values of the storage regions reg1 and reg2 are reset to the signal reference value SG.

Thus, in the present embodiment, the substitution range is set based on the normal frame data located immediately before the error-present frame data, and the error-present frame data is substituted with its corresponding set data lying within the set substitution range. It is therefore possible to prevent the error-present frame data and the normal frame data located immediately before it from extremely differing from each other and to suppress noise. That is, it is possible to suppress noise in digital audio data while the enlargement of a communication range by data communications at a low bit rate is being realized. Incidentally, the routine processing shown in FIG. 3 can be realized by software processing, but may of course be realized by hardware.

### Second Preferred Embodiment

A second preferred embodiment of the present invention will next be explained. Incidentally, the same reference numerals are respectively attached to the same portions as those employed in the first preferred embodiment, and their detailed explanations will therefore be omitted.

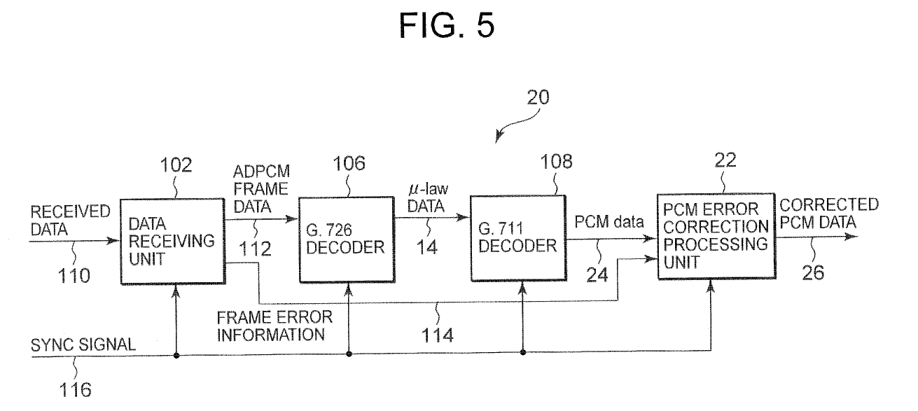

A schematic block diagram of a decoder 20 according to the present embodiment is shown in FIG. 5. As shown in the same drawing, the decoder 20 is different from the decoder 10 shown in FIG. 1 in that a PCM error correction processor or processing unit 22 is provided instead of the law error correction processing unit 12 and provided in a stage subsequent to a G. 711 decoder 108 without being provided between the G. 726 decoder 106 and the G. 711 decoder 108 as shown in FIG. 1. Incidentally, the μ-law error correction processing unit 12 and the PCM error correction processing unit 22 perform similar processing.

Namely, the μ-law error correction processing unit 12 shown in FIG. 1 performs the processing of FIG. 3 on the μ-law data 14 outputted from the G. 726 decoder 106 and outputs the corrected μ-law data 14. The PCM error correction processing unit 22 shown in FIG. 5 performs the processing of FIG. 3 on PCM data 24 outputted from the G. 711 decoder 108 and outputs corrected PCM data 26.

Sine both of the μ-law data 14 and the PCM data 24 are PCM system-based data and are of volume information, such processing as shown in FIG. 3 is enabled. Since ADPCM data is of one encoded by prediction and conversion using difference information about a change in volume, the μ-law error correction processing unit 12 of FIG. 1 and the PCM error correction processing unit 22 cannot be provided between the receiving unit 102 and G. 726 decoder 106.

Thus, the processing shown in FIG.3 is performed on the PCM data 24 outputted from the G. 711 decoder 108 thereby to substitute error-present frame data with its corresponding data lying within a set substitution range. It is therefore possible to prevent the error-contained frame data and normal frame data located immediately before it from extremely differing from each other and to suppress noise.

In each of the above embodiments, the maximum value of the normal frame data lying immediately before the error-present frame data is stored in its corresponding storage region reg1 as the upper limit of the substitution range, and the minimum value thereof is stored in its corresponding storage region reg2 as the lower limit of the substitution range. When, however, the signal reference value SG is set as ‘0’, either of the absolute value of the maximum value and the absolute value of the minimum value may be stored in the storage region reg1, and the substitution range may be set based on the value thereof. That is, when the absolute value stored in the storage region reg1 is a given value ‘A’, for example, a substitution range with ‘−A’ as its lower limit and ‘+A’ as its upper limit is set. Thus, only the storage region reg1 is sufficient and a memory can be reduced.

Although the audio waveform represented by the error-present frame data is larger in amplitude than the audio waveform represented by the normal frame data in the example shown in FIG. 4, there may be a case in which the error-present frame data becomes smaller in amplitude than the normal frame data in reverse.

When the signal reference value SG is of ‘0’ in such a case, for example, the absolute value of the maximum value of the normal frame data lying immediately before the error-present frame data is stored in the storage region reg1, and the absolute value of the minimum value of the normal frame data is stored in the storage region reg2. In this condition, the substitution range may be set based on the absolute value of the maximum value and the absolute value of the minimum value.

Described specifically, for example, when the absolute value of the maximum value is ‘A’ and the absolute value of the minimum value is ‘B’, a first substitution range is set between ‘+A’ and ‘+B’, and a second substitution range is set between ‘−A’ and ‘−B’. Namely, the substitution ranges are respectively set to the positive and negative regions. Positive data lying outside the first substitution range, of error-present frame data is replaced to take or assume a value lying within the first substitution range. Negative data lying outside the second substitution range, of the error-present frame data is replaced to take a value lying within the second substitution range. Thus, the error-contained frame data can be substituted with data that is not much different from the normal frame data lying immediately before it, and noise can be suppressed.

Although the values stored in the storage regions reg1 and reg2 have been set to the maximum and minimum values of the normal frame data lying immediately before the error-present frame data, the absolute values thereof and the like in the respective embodiments, the present invention is not limited to them. When the signal reference value SG is ‘0’, for example, the values of arbitrary positions in the positive and negative regions, an average value, a medium value and the like may be used.

While the preferred forms of the present invention have been described, it is to be understood that modifications will be apparent to those skilled in the art without departing from the spirit of the invention. The scope of the invention is to be determined solely by the following claims.

What is claimed is:

1. A digital voice communication method comprising the steps of:
detecting whether an error exists every frame data obtained by dividing received data;
when the error exists in said each frame data, setting a substitution range, based on normal frame data located immediately before the corresponding error-present frame data; and
substituting data lying outside the substitution range, of the error-present frame data with data lying within the substitution range.

2. The digital voice communication method according to claim 1, wherein said setting step sets a maximum value of data contained in the normal frame data as an upper limit of the substitution range and sets a minimum value of data contained in the normal frame data as a lower limit of the substitution range.

3. The digital voice communication method according to claim 1, wherein said setting step sets a first substitution range for replacing positive data and a second substitution range for replacing negative data, based on an absolute value of the maximum value of the data contained in the normal frame data and an absolute value of the minimum value of the data contained in the normal frame data.

4. The digital voice communication method according to claim 1, wherein the frame data is of data encoded by a PCM system.

5. The digital voice communication method according to claim 2, wherein the frame data is of data encoded by a PCM system.

6. The digital voice communication method according to claim 3, wherein the frame data is of data encoded by a PCM system.

7. A digital voice communication apparatus comprising:
a detector which detects whether an error exists every frame data obtained by dividing received data;
a setter which sets a substitution range, when the error exists in said each frame data, based on normal frame data located immediately before the corresponding error-present frame data; and
a substituter which substitutes data lying outside the substitution range, of the error-present frame data with data lying within the substitution range.
